(19) United States
(12) Patent Application Publication
(10) Pub. No.: US 2025/0239065 A1
(43) Pub. Date: Jul. 24, 2025

(54) METHOD OF VIDEO POST-PROCESSING, METHOD OF VIDEO COMPRESSION, AND SYSTEM FOR VIDEO COMPRESSION

(71) Applicant: GUANGDONG OPPO MOBILE TELECOMMUNICATIONS CORP., LTD., Dongguan (CN)

(72) Inventors: Cheolkon JUNG, Dongguan (CN); Yusong HU, Dongguan (CN)

(21) Appl. No.: 19/171,748

(22) Filed: Apr. 7, 2025

Related U.S. Application Data
(63) Continuation of application No. PCT/CN2022/135890, filed on Dec. 1, 2022.

(30) Foreign Application Priority Data
Oct. 13, 2022 (WO) PCT/CN2022/125211

(51) Int. Cl. G06V 10/82; G06V 10/52; G06V 10/77; G06V 20/40; H04N 19/85

(52) U.S. Cl. CPC G06V 10/82; G06V 10/52; G06V 10/7715; G06V 20/46; H04N 19/85

(57) ABSTRACT

According to one aspect of the present disclosure, a method of video post-processing may include receiving, by a processor, a plurality of input feature maps associated with an image. The plurality of input feature maps may be generated by a video pre-processing network. The video post-processing method may include inputting, by the processor, the plurality of input feature maps into a first depth-wise separable convolutional (DSC) network of a fast residual channel attention network (FRCAN) component. The video post-processing method may include outputting, by the processor, a first set of output feature maps from the first DSC network of the FRCAN component.

### CROSS REFERENCE TO RELATED APPLICATION(S)

This application is a continuation of International Application No. PCT/CN2022/135890, filed Dec. 1, 2022, which claims priority to International Application No. PCT/CN2022/125211, filed Oct. 13, 2022, the disclosures of which are incorporated herein by reference in their entireties.

### BACKGROUND

Embodiments of the present disclosure relate to video coding, and more particular, to a method of video post-processing, a method of video compression, and a system for video compression.

Digital video has become mainstream and is being used in a wide range of applications including digital television, video telephony, and teleconferencing. These digital video applications are feasible because of the advances in computing and communication technologies as well as efficient video coding techniques. Various video coding techniques may be used to compress video data, such that coding on the video data can be performed using one or more video coding standards. Exemplary video coding standards may include, but not limited to, versatile video coding (H.266/VVC), high-efficiency video coding (H.265/HEVC), advanced video coding (H.264/AVC), moving picture expert group (MPEG) coding, to name a few.

### SUMMARY

According to one aspect of the present disclosure, a method of video post-processing is provided. The method may include receiving, by a processor, a plurality of input feature maps associated with an image. The plurality of input feature maps may be generated by a video pre-processing network. The method may include inputting, by the processor, the plurality of input feature maps into a first depth-wise separable convolutional (DSC) network of a fast residual channel attention network (FRCAN) component. The method may include outputting, by the processor, a first set of output feature maps from the first DSC network of the FRCAN component.

According to a further aspect of the present disclosure, a method of video compression is provided. The method may include performing, by a processor, pre-processing of an input image using a pre-processing network to generate an encoded image. The method may include performing, by the processor, post-processing on the encoded image using a post-processing network to generate a decoded compressed image. The pre-processing network and the post-processing network may be asymmetric.

According to yet another aspect of the present disclosure, a system for video compression is provided. The system may include a memory configured to store instructions. The system may include a processor coupled to the memory and configured to, upon executing the instructions, perform pre-processing of an input image using a pre-processing network to generate an encoded image. The system may include a processor coupled to the memory and configured to, upon executing the instructions, perform post-processing on the encoded image using a post-processing network to generate a decoded compressed image. The pre-processing network and the post-processing network may be asymmetric.

These illustrative embodiments are mentioned not to limit or define the present disclosure, but to provide examples to aid understanding thereof. Additional embodiments are described in the Detailed Description, and further description is provided there.

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1 illustrates a block diagram of an exemplary encoding system, according to some embodiments of the present disclosure.

FIG. 2 illustrates a block diagram of an exemplary decoding system, according to some embodiments of the present disclosure.

FIG. 3 illustrates a detailed block diagram of an exemplary video coding network, according to some embodiments of the present disclosure.

FIG. 4 illustrates a detailed block diagram of an exemplary channel-wise auto-regressive entropy model deployed in the exemplary video coding network of FIG. 3, according to some embodiments of the present disclosure.

FIG. 5 illustrates a depth-wise separable convolution (DSC) that may be performed by the exemplary decoder of FIG. 2, according to some embodiments of the present disclosure.

FIG. 6 illustrates a residual channel attention block (RCAB) as an exemplary FRCAN component that includes a DSC network and is deployed in the exemplary decoder of FIG. 2, according to some embodiments of the present disclosure.

FIG. 7 illustrates an exemplary residual upsampling component deployed in the exemplary decoder of FIG. 2, according to some embodiments of the present disclosure.

FIG. 8 illustrates an exemplary residual-in-residual dense block (RRDB) component deployed in the exemplary decoder of FIG. 2, according to some embodiments of the present disclosure.

FIG. 9 illustrates a graphical representation of a peak-signal-to-noise ratio (PSNR) rate-distortion (RD) performance for video coding achieved using the exemplary video coding network of FIG. 3, according to some aspects of the present disclosure.

FIG. 10 illustrates a graphical representation of a Multi-Scale-Structural SIMilarity (MS-SSIM) RD performance for video coding achieved by the exemplary video coding network of FIG. 3, according to some aspects of the present disclosure.

FIG. 11 illustrates a graphical representation of PSNR versus bit-rate for video compression using an exemplary FRCAN and without the exemplary FRCAN, according to some aspects of the present disclosure.

FIG. 12 illustrates a graphical representation of MS-SSIM versus bit-rate for video compression using an exemplary FRCAN and without the exemplary FRCAN, according to some aspects of the present disclosure.

FIG. 13 illustrates a flow chart of a first exemplary method of video coding, according to some aspects of the present disclosure.

FIG. 14 illustrates a flow chart of a second exemplary method of video coding, according to some aspects of the present disclosure.

Embodiments of the present disclosure will be described with reference to the accompanying drawings.

### DETAILED DESCRIPTION

Although some configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “one embodiment,” “an embodiment,” “an example embodiment,” “some embodiments,” “certain embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment, it would be within the knowledge of a person skilled in the pertinent art to effect such feature, structure, or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Various aspects of video coding systems will now be described with reference to various apparatus and methods. These apparatus and methods will be described in the following detailed description and illustrated in the accompanying drawings by various modules, components, circuits, steps, operations, processes, algorithms, etc. (collectively referred to as “elements”). These elements may be implemented using electronic hardware, firmware, computer software, or any combination thereof. Whether such elements are implemented as hardware, firmware, or software depends upon the particular application and design constraints imposed on the overall system.

The techniques described herein may be used for various video coding applications. As described herein, video coding includes both encoding and decoding a video. Encoding and decoding of a video can be performed by the unit of block. For example, an encoding/decoding process such as transform, quantization, prediction, in-loop filtering, reconstruction, or the like may be performed on a coding block, a transform block, or a prediction block. As described herein, a block to be encoded/decoded will be referred to as a “current block.” For example, the current block may represent a coding block, a transform block, or a prediction block according to a current encoding/decoding process. In addition, it is understood that the term “unit” used in the present disclosure indicates a basic unit for performing a specific encoding/decoding process, and the term “block” indicates a sample array of a predetermined size. Unless otherwise stated, the “block,” “unit,” and “component” may be used interchangeably.

Current image compression methods can be divided into two categories: traditional image compression (e.g., JPEG, JPEG2000, BPG) and recent deep learning-based image compression.

Traditional image compression uses module-based encoder/decoder (codec) blocks to remove spatial redundancy and improve image-coding efficiency. To that end, these methods may employ a fixed transformation matrix, intra-prediction units, quantization units, adaptive arithmetic encoders, and various deblocking or loop filters. With the rapid development of new image formats and the popularity of high-resolution mobile devices, there is a need to develop a new video coding technology that replaces the existing image compression standards.

In recent years, learned-image compression (also referred to as “convolutional neural network (CNN)-based image compression”), which is based on a variational auto-encoder (VAE), has achieved better rate-distortion performance than conventional image compression methods in terms of PSNR and MS-SSIM, showing great potential for a practical compression use.

For encoding, the VAE-based image compression methods use linear and nonlinear parametric transforms to map an image into a latent space. After quantization, an entropy estimation model predicts the distributions of latent data, then a lossless Context-based Adaptive Binary Arithmetic Coding (CABAC) or Range Coder compresses the latent data into the bit stream. Meanwhile, hyper-prior, auto-regressive priors, and Gaussian Mixture Model (GMM) allow the entropy estimation components to precisely predict distributions of latent data, and achieve better RD performance. For decoding, the lossless CABAC or Range Coder decompresses the bit stream; then the decompressed latent data is mapped to reconstructed images by a linear and nonlinear parametric synthesis transform. Combining the above sequential units, those models could be trained end-to-end.

One core problem of existing CNN-based compression methods is that the original convolutional layer is designed for the high-level global feature distillation, rather than the low-level local detail restoration. This inevitably limits further performance improvement.

To overcome these and other challenges of CNN-based compression, the present disclosure provides an exemplary CNN-based compression network designed with a hybrid network structure. This hybrid-network structure may be based on residual learning and channel attention, which is applied to the post-processing network (also referred to herein as a “decoder”) in an end-to-end video coding network (also referred to herein as a “video coding system”) based on deep learning. To that end, the present disclosure provides a FRCAN with a channel attention (CA) layer and a DSC network to increase the processing speed of the post-processing network while generating informative features in an image. By deploying DSC network(s) in the post-processing network with residual learning for upsampling, the video coding system of the present disclosure captures image features lost during decoding, thereby reducing the compression ratio. Compared with existing end-to-end image coding systems, the proposed video coding system achieves a compression speed and a decompression speed that is increased by around factors of 1.5 and 1.23, respectively, while also achieving gains in PSNR and MS-SSIM at a high-bitrate.

Moreover, the exemplary video coding system of the present disclosure uses an asymmetric coding and decoding framework to enhance both coding efficiency and decoding quality. An asymmetric coding and decoding framework may refer to the different types of convolutions performed in the encoder and the decoder. For instance, the encoder may use standard convolutions, while the decoder uses depth-wise separable convolutions. This framework has two advantages: 1) simplifying encoding, which improves the encoding speed and reduces the compressed bit stream, and 2) compensating for the information lost during compression and improving the quality of decoded images by using complex DSC networks.

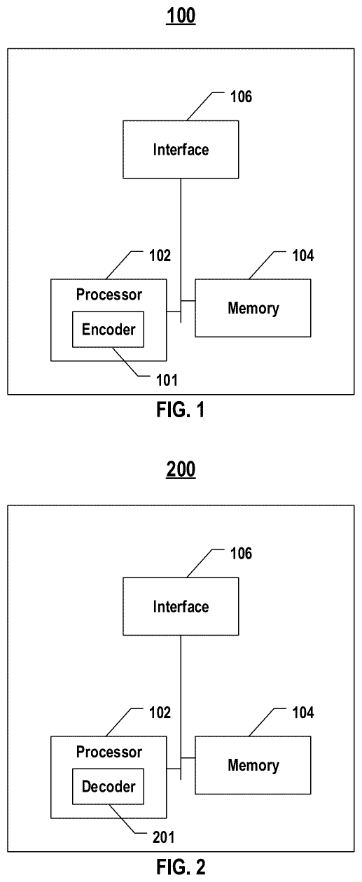

Still further, the DSC network(s) deployed in the post-processing network described herein improve the network speed, while at the same time reducing the network parameters. The residual learning performed by the post-processing network may generate additional features that have been lost, thereby reducing the code stream after image compression. For example, the CA network of the FRCAN component may capture informative features, which may be omitted by the pre-processing network's feature maps, thereby achieving an improvement of both runtime latency and visual quality. Additional details of the exemplary video coding system of the present disclosure are provided below in connection with FIGS. 1-14.

FIG. 1 illustrates a block diagram of an exemplary encoding system 100, according to some embodiments of the present disclosure. FIG. 2 illustrates a block diagram of an exemplary decoding system 200, according to some embodiments of the present disclosure. Each system 100 or 200 may be applied or integrated into various systems and apparatus capable of data processing, such as computers and wireless communication devices. For example, system 100 or 200 may be the entirety or part of a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having data processing capability. As shown in FIGS. 1 and 2, system 100 or 200 may include a processor 102, a memory 104, and an interface 106. These components are shown as connected to one another by a bus, but other connection types are also permitted. It is understood that system 100 or 200 may include any other suitable components for performing functions described here.

Processor 102 may include microprocessors, such as graphic processing unit (GPU), image signal processor (ISP), central processing unit (CPU), digital signal processor (DSP), tensor processing unit (TPU), vision processing unit (VPU), neural processing unit (NPU), synergistic processing unit (SPU), or physics processing unit (PPU), microcontroller units (MCUs), application-specific integrated circuits (ASICs), field-programmable gate arrays (FPGAs), programmable logic devices (PLDs), state machines, gated logic, discrete hardware circuits, and other suitable hardware configured to perform the various functions described throughout the present disclosure. Although only one processor is shown in FIGS. 1 and 2, it is understood that multiple processors can be included. Processor 102 may be a hardware device having one or more processing cores. Processor 102 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. Software can include computer instructions written in an interpreted language, a compiled language, or machine code. Other techniques for instructing hardware are also permitted under the broad category of software.

Memory 104 can broadly include both memory (a.k.a, primary/system memory) and storage (a.k.a., secondary memory). For example, memory 104 may include random-access memory (RAM), read-only memory (ROM), static RAM (SRAM), dynamic RAM (DRAM), ferro-electric RAM (FRAM), electrically erasable programmable ROM (EEPROM), compact disc read-only memory (CD-ROM) or other optical disk storage, hard disk drive (HDD), such as magnetic disk storage or other magnetic storage devices, Flash drive, solid-state drive (SSD), or any other medium that can be used to carry or store desired program code in the form of instructions that can be accessed and executed by processor 102. Broadly, memory 104 may be embodied by any computer-readable medium, such as a non-transitory computer-readable medium. Although only one memory is shown in FIGS. 1 and 2, it is understood that multiple memories can be included.

Interface 106 can broadly include a data interface and a communication interface that is configured to receive and transmit a signal in a process of receiving and transmitting information with other external network elements. For example, interface 106 may include input/output (I/O) devices and wired or wireless transceivers. Although only one interface is shown in FIGS. 1 and 2, it is understood that multiple interfaces can be included.

Processor 102, memory 104, and interface 106 may be implemented in various forms in system 100 or 200 for performing video coding functions. In some embodiments, processor 102, memory 104, and interface 106 of system 100 or 200 are implemented (e.g., integrated) on one or more system-on-chips (SoCs). In one example, processor 102, memory 104, and interface 106 may be integrated on an application processor (AP) SoC that handles application processing in an operating system (OS) environment, including running video encoding and decoding applications. In another example, processor 102, memory 104, and interface 106 may be integrated on a specialized processor chip for video coding, such as a GPU or ISP chip dedicated to image and video processing in a real-time operating system (RTOS).

As shown in FIG. 1, in encoding system 100, processor 102 may include one or more modules, such as an encoder 101 (also referred to herein as a “pre-processing network”). Although FIG. 1 shows that encoder 101 is within one processor 102, it is understood that encoder 101 may include one or more sub-modules that can be implemented on different processors located closely or remotely with each other. Encoder 101 (and any corresponding sub-modules or sub-units) can be hardware units (e.g., portions of an integrated circuit) of processor 102 designed for use with other components or software units implemented by processor 102 through executing at least part of a program, i.e., instructions. The instructions of the program may be stored on a computer-readable medium, such as memory 104, and when executed by processor 102, it may perform a process having one or more functions related to video encoding, such as picture partitioning, inter prediction, intra prediction, transformation, quantization, filtering, entropy encoding, etc., as described below in detail.

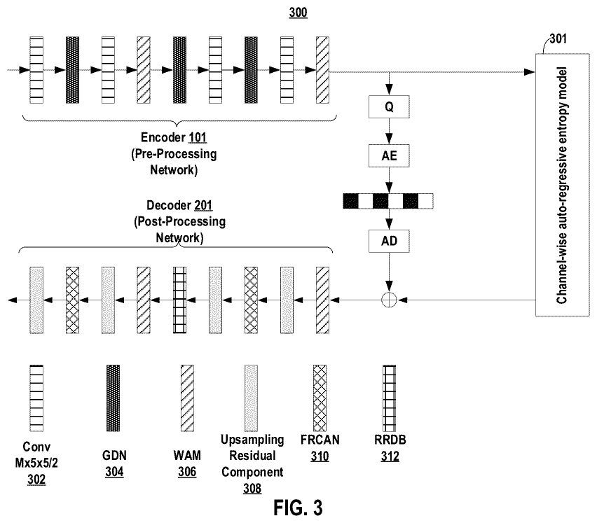

Similarly, as shown in FIG. 2, in decoding system 200, processor 102 may include one or more modules, such as a decoder 201 (also referred to herein as a “post-processing network”). Although FIG. 2 shows that decoder 201 is within one processor 102, it is understood that decoder 201 may include one or more sub-modules that can be implemented on different processors located closely or remotely with each other. Decoder 201 (and any corresponding sub-modules or sub-units) can be hardware units (e.g., portions of an integrated circuit) of processor 102 designed for use with other components or software units implemented by processor 102 through executing at least part of a program, i.e., instructions. The instructions of the program may be stored on a computer-readable medium, such as memory 104, and when executed by processor 102, it may perform a process having one or more functions related to video decoding, such as entropy decoding, inverse quantization, inverse transformation, inter prediction, intra prediction, filtering, as described below in detail. As illustrated in FIG. 3, encoder 101 and decoder 201 may be designed with an asymmetrical coding/decoding framework in that encoder 101 performs standard CNN(s), while decoder 201 employs DSC network(s).

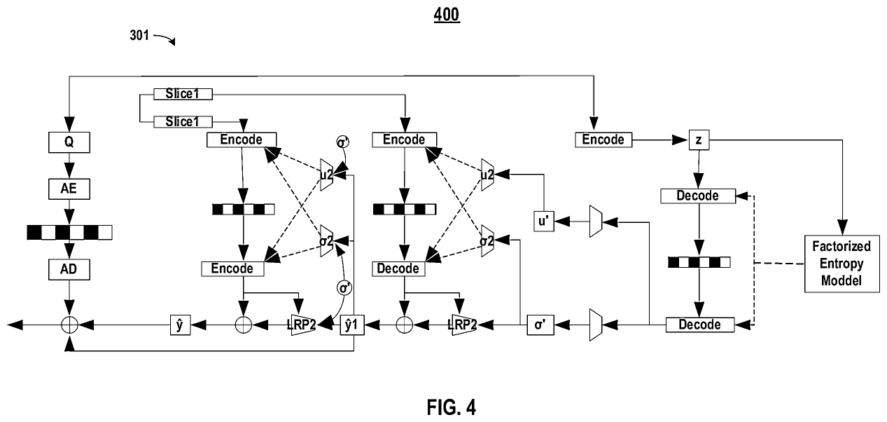

FIG. 3 illustrates a detailed block diagram of an exemplary video coding network 300 (referred to hereinafter as “video coding network 300”), according to some embodiments of the present disclosure. FIG. 4 illustrates a detailed block diagram 400 of an exemplary channel-wise auto-regressive entropy model 301 (referred to hereinafter as “entropy model 301”) deployed in the exemplary video coding network of FIG. 3, according to some embodiments of the present disclosure. FIGS. 3 and 4 will be described together.

As shown in FIG. 3, video coding network 300 may include, e.g., encoder 101, decoder 201, and a channel-wise auto-regressive entropy model 301. Encoder 101 may receive an image from a video. Encoder 101 may include convolutional downsampling component(s) 302, generalized divisive normalization (GDN) components 304, and window attention mechanism (WAM) component(s) 306. Convolutional downsampling component(s) 302 may be responsible for extracting the input image features. GDN component(s) 304 may be used to normalize intermediate features and increase nonlinearity. WAM component(s) 306 may focus on areas with high contrast and use more bits in these complex areas. In addition, WAM reconstructed images may increase image-clarity in terms of texture details. Encoder 101 may output a plurality of feature maps, which may be input into entropy model 301, the structure of which is illustrated in FIG. 4.

Referring to FIG. 4, by using the conditional context based on channel and residual prediction module of potential representation, the network architecture of entropy model 301 may be optimized. By optimizing entropy model 301, improved RD performance may be achieved, as compared to the existing context entropy model, while at the same time minimizing serial processing.

Referring back to FIG. 3, after entropy modeling, the feature maps may be input into decoder 201. Decoder 201 may include, e.g., WAM component(s) 306, upscaling residual upsampling component(s) 308, FRCAN component(s) 310, and RRDB component(s) 312. Residual upsampling component(s) 308, FRCAN component(s) 310, and RRDB component(s) 312 may be responsible for generating more features to compensate for the feature loss during encoding. WAM component(s) 306 in encoder 101 and decoder 201 may have the same scope.

By training video coding network 300 using an asymmetric encoder 101 and decoder 201, different properties may be balanced to minimize the loss function, which is a weighted sum of the terms measuring image reconstruction quality and the compression rate. The loss function L of the image compression model generated by video coding network 300 may be represented by expression (1) shown below.

L=R+λ·D=E_{x˜p}_{ₓ}[−log₂p_{ŷ|\hat{z}}(ŷ|\hat{z})−log₂p_{z}(\hat{z})]+λ·E_{z˜p}_{ₓ}[d(x,\hat{x}) ] (1),

where λ controls the trade-off between compression rate and distortion, R is the bitrate of latent data ŷ and \hat{z}, d(x, \hat{x}) is the distortion between the raw image x and the reconstructed image \hat{x}.

Moreover, video coding network 300 of the present disclosure uses an asymmetric coding (e.g., pre-processing) and decoding (e.g., post-processing) framework to enhance both coding efficiency and decoding quality. An asymmetric coding and decoding framework may refer to the types of convolutions performed in the encoder and the decoder. This framework has two advantages: 1) simplifying encoding, which improves the encoding speed and reduces the compressed bit stream, and 2) compensating for the information lost during compression and improving the quality of decoded images by using complex DSC networks. DSC network(s) deployed in FRCAN component 310 and RRDB component 312 improve the network speed, while at the same time reducing the network parameters. The residual learning performed by decoder 201 may generate additional features that have been lost, thereby reducing the code stream after image compression. For example, the channel attention block of RCAB (CA_Block) 608 in FRCAN component 310 may capture informative features by weighting, which may be omitted by the pre-processing network's feature maps, thereby achieving an improvement of both runtime latency and visual quality.

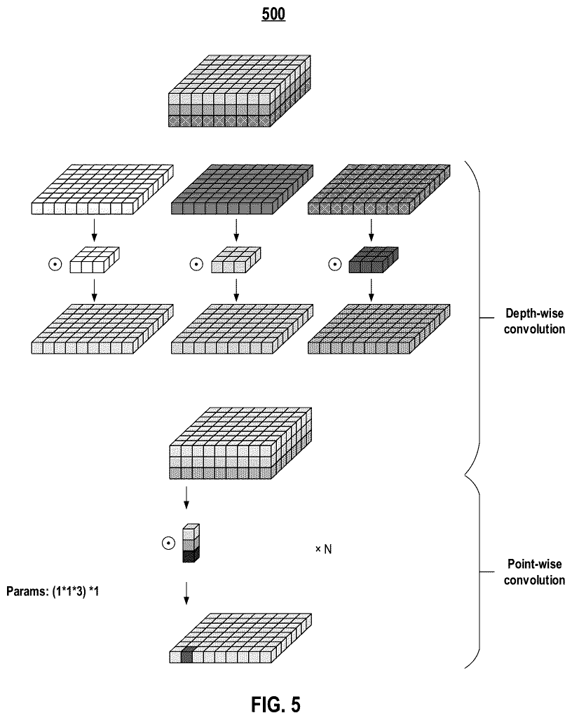

FIG. 5 illustrates a depth-wise separable convolution 500 that may be performed by the exemplary decoder 201 of FIG. 2, according to some embodiments of the present disclosure. To improve the performance of FRCAN component(s) 310 and RRDB component(s) 312 in decoder 201, depth-wise separable convolutions may be performed.

Still referring to FIG. 5, a depth-wise separable convolution may be divided into two processes: 1) channel-by-channel convolution and 2) point-wise convolution. One convolutional core/layer of the depth-wise separable convolution is responsible for one channel, and one channel is convolved by only one convolution core/layer. The number of feature map channels generated in this process may be the same as the number of input channels. After the depth-wise convolution is completed, the number of feature maps is the same as the number of channels in the input layer; thus, the feature map may not be expanded. Moreover, this operation convolves each channel of the input layer independently, and does not effectively use the feature information of different channels in the same spatial location.

Therefore, point-wise convolution may be performed to combine these feature maps to generate a new feature map. Point-wise convolution is similar to a standard convolution operation in that the size of its convolution kernel is 1×one×M, where M is the number of channels on the upper layer. The point-wise convolution operation combines the maps in the depth direction to generate a new feature map. There are several output feature maps with several convolution cores. The shape of the convolution kernel is 1×1×the number of input channels x the number of the output channels. With the same input, four feature maps may be obtained from a point-wise convolution. The number of parameters of the depth-wise separable convolution is about one-third of that of the conventional convolution. Therefore, on the premise that the parameters are the same, the number of layers of the neural network based on the depth-wise separable convolution goes deeper.

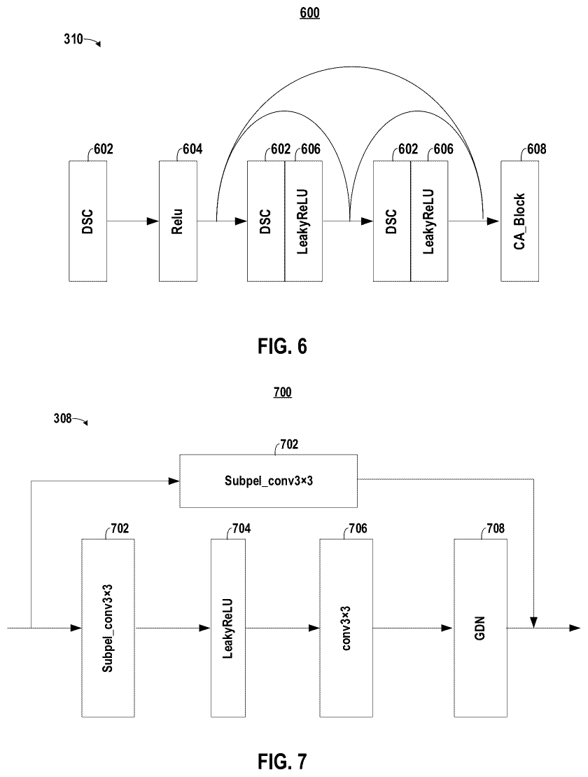

FIG. 6 illustrates a block diagram 600 of a residual channel attention block (RCAB) as exemplary FRCAN component(s) 310 of FIG. 3, according to some embodiments of the present disclosure. Referring to FIG. 6, the convolutional layer in front of CA layer 608 is replaced with a simplified residual-in-residual dense block (RRDB). By using a dense residual structure, FRCAN component(s) 310 may generate informative image features to compensate for feature loss during compression, thus improving the quality of the image generated after decompression. The dense residual structure may include, e.g., a plurality of DSC networks 602, a Relu layer 604, and a plurality of LeakyRelU layers 606. Four residual channel attention blocks (RCABs) (as compared to twelve RCABs in other systems) may be combined to form one of the FRCAN component 310, which achieves runtime reduction and quality enhancement.

FIG. 7 illustrates a detailed block diagram 700 of the residual upsampling component 308 of FIG. 3, according to some embodiments of the present disclosure. Referring to FIG. 7, using subpixel convolutional layer 702, residual upsampling component 308 may perform a mapping from a small rectangle to a large rectangle, thus improving the resolution. The LeakyRelu layer 704 fixes neuron death in Relu. It has a small positive slope in the negative area, so it can back-propagate even for negative input values. The residual structure restores more features. Convolutional layer 706 performs pixel-based convolution. GDN layer 708 may normalize intermediate features and increase nonlinearity.

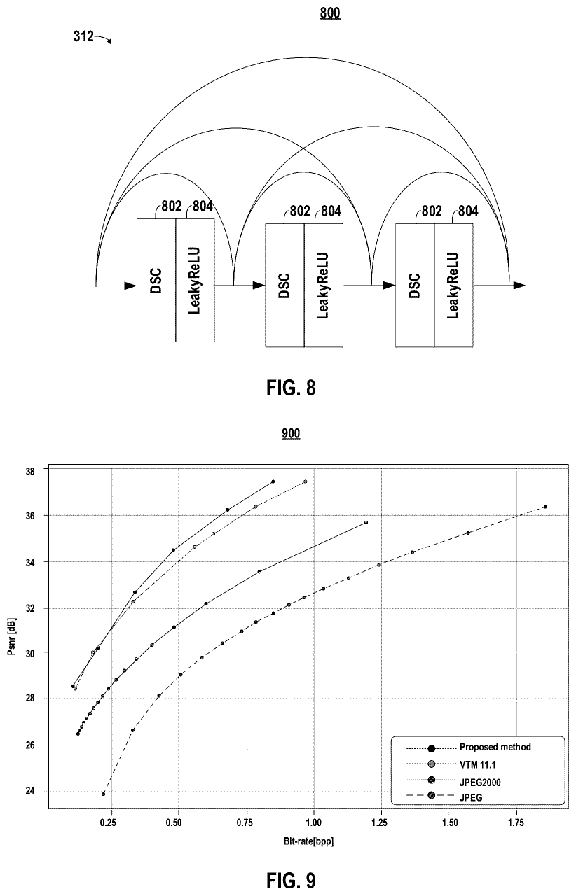

FIG. 8 illustrates a block diagram 800 of the exemplary RRDB component 312 component of FIG. 3, according to some embodiments of the present disclosure. As shown in FIG. 8, DSC networks 802 replace the standard convolutional networks to reduce processing latency. RRDB component 312 also includes LeakyRelu layers 804.

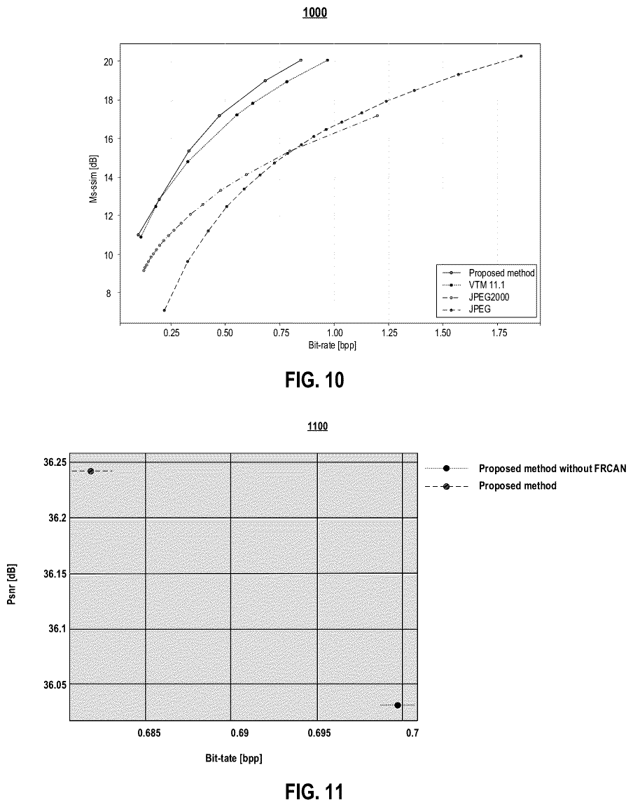

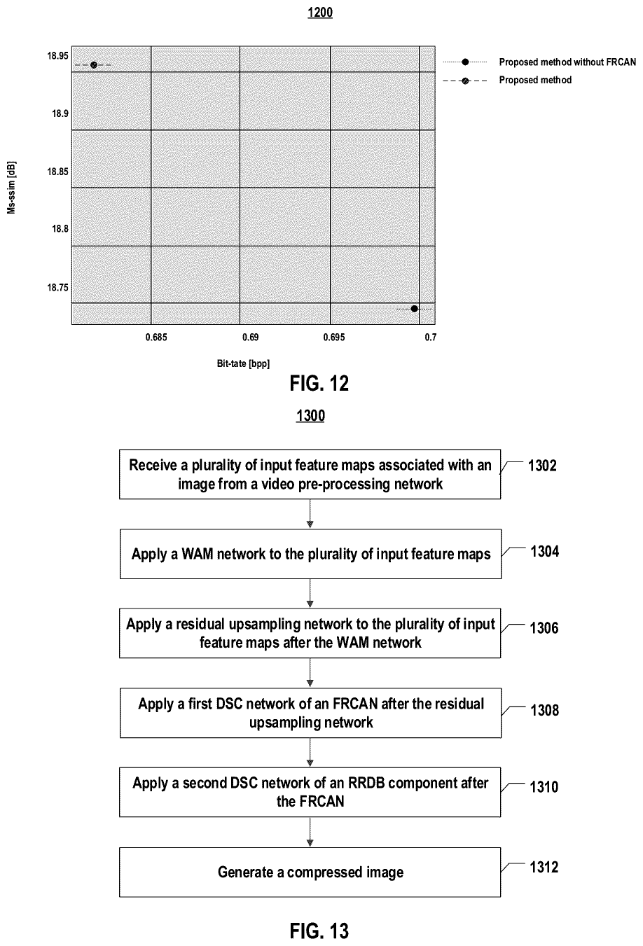

FIG. 9 illustrates a graphical representation 900 of a PSNR RD performance for video coding achieved by video coding network 300 of FIG. 3, according to some aspects of the present disclosure. FIG. 10 illustrates a graphical representation 1000 of an MS-SSIM RD performance for video coding achieved by video coding network 300 of FIG. 3, according to some aspects of the present disclosure. FIG. 11 illustrates a graphical representation 1100 of PSNR versus bit-rate for video compression using FRCAN component 310 and without FRCAN component 310, according to some aspects of the present disclosure. FIG. 12 illustrates a graphical representation 1200 of MS-SSIM versus bit-rate for video compression using an exemplary FRCAN component 310 and without FRCAN component 310, according to some aspects of the present disclosure.

FIG. 13 illustrates a flow chart of an exemplary method 1300 of video encoding, according to some embodiments of the present disclosure. Method 1300 may be performed by an apparatus, e.g., such as decoder 201, video coding network 300, or any other suitable video encoding and/or compression systems. Method 1300 may include operations 1302-1312 as described below. It is understood that some of the operations may be optional, and some of the operations may be performed simultaneously, or in a different order other than shown in FIG. 13.

Referring to FIG. 13, at 1302, the apparatus may receive a plurality of input feature maps associated with an image from a video pre-processing network. For example, referring to FIG. 3, after entropy modeling, the feature maps may be input into decoder 201.

At 1304, the apparatus may apply a WAM network to the plurality of input feature maps. For example, referring to FIG. 3, WAM component(s) 306 of decoder 201 may focus on areas with high-contrast and use more bits in these complex areas. In addition, WAM reconstructed images may increase image-clarity in terms of texture details.

At 1306, the apparatus may apply a residual upsampling network to the plurality of input feature maps after the WAM network. For example, referring to FIG. 3, residual upsampling component(s) 308 may be responsible for generating more features to compensate for the feature loss during encoding. Referring to FIG. 7, using subpixel convolutional layer 702, residual upsampling component 308 may perform a mapping from a small rectangle to a large rectangle, thus improving the resolution. The LeakyRelu layer 704 fixes neuron death in Relu. It has a small positive slope in the negative area, so it can back-propagate even for negative input values. The residual structure restores more features. Convolutional layer 706 performs pixel-based convolution. GDN layer 708 may normalize intermediate features and increase nonlinearity.

At 1308, the apparatus may apply a first DSC network of a FRCAN after the residual upsampling network. For example, referring to FIG. 6, the convolutional layer in front of the CA layer 608 is replaced with a simplified RRDB. By using a dense residual structure, FRCAN component(s) 310 may generate informative image features to compensate for feature loss during compression, thus improving the quality of the image generated after decompression. The dense residual structure may include, e.g., a plurality of DSC networks 602, a Relu layer 604, and a plurality of LeakyRelU layers 606. Four RCAB components (as compared to twelve in other systems) may be combined to form one of the FRCAN component 310, which achieves runtime reduction and quality enhancement.

At 1310, the apparatus may apply a second DSC network of an RRDB component after the FRCAN. For example, referring to FIG. 8, DSC networks 802 replaces the standard convolutional networks to reduce processing latency.

At 1312, the apparatus may generate a compressed image. For example, referring to FIG. 3, decoder 201 outputs a compressed image after the post-processing is complete.

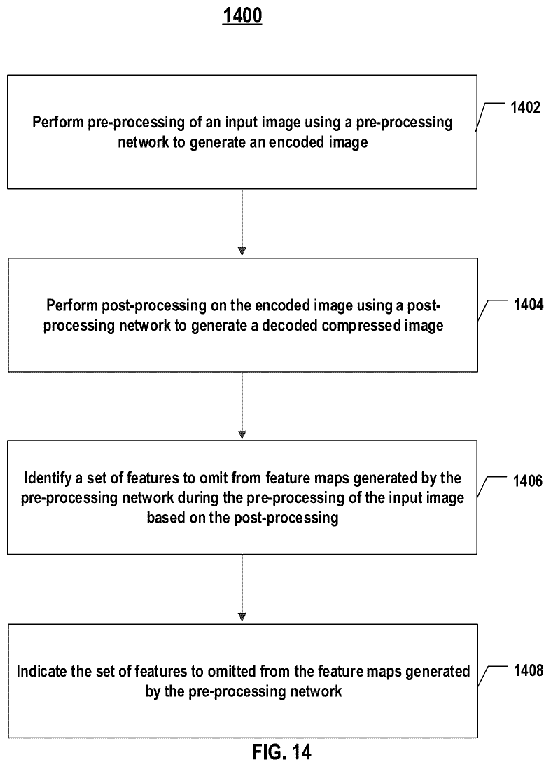

FIG. 14 illustrates a flow chart of an exemplary method 1400 of video encoding, according to some embodiments of the present disclosure. Method 1400 may be performed by an apparatus, e.g., video coding network 300 or any other suitable video decoding and/or decompression systems. Method 1400 may include operations 1402-1408 as described below. It is understood that some of the operations may be optional, and some of the operations may be performed simultaneously, or in a different order other than shown in FIG. 14.

Referring to FIG. 14, at 1402, the apparatus may perform pre-processing of an input image using a pre-processing network to generate an encoded image. For example, referring to FIG. 3, encoder 101 (e.g., a pre-processing network) may receive an image from a video. Encoder 101 may include convolutional downsampling component(s) 302, GDN components 304, and WAM component(s) 306. Convolutional downsampling component(s) 302 may be responsible for extracting the input image features. GDN component(s) 304 may be used to normalize intermediate features and increase nonlinearity. WAM component(s) 306 may focus on areas with high-contrast and use more bits in these complex areas. In addition, WAM reconstructed images may increase image-clarity in terms of texture details. Encoder 101 may output a plurality of feature maps, which may be input into entropy model 301.

At 1404, the apparatus may perform post-processing on the encoded image using a post-processing network to generate a decoded compressed image. Referring to FIG. 3, after entropy modeling, the feature maps may be input into decoder 201. Decoder 201 may include, e.g., WAM component(s) 306, upscaling residual upsampling component(s) 308, FRCAN component(s) 310, and RRDB component(s) 312. Residual upsampling component(s) 308, FRCAN component(s) 310, and RRDB component(s) 312 may be responsible for generating more features to compensate for the feature loss during encoding. WAM component(s) 306 in encoder 101 and decoder 201 may have the same scope.

At 1406, the apparatus may identify a set of features to omit from feature maps generated by the pre-processing network during the pre-processing of the input image based on the post-processing. For example, referring to FIG. 3, video coding network 300 of the present disclosure uses an asymmetric coding (e.g., pre-processing) and decoding (e.g., post-processing) framework to enhance both coding efficiency and decoding quality. An asymmetric coding and decoding framework may refer to the types of convolutions performed in the encoder and the decoder. This framework has two advantages: 1) simplifying encoding, which improves the encoding speed and reduces the compressed bit stream, and 2) compensating for the information lost during compression and improving the quality of decoded images by using complex DSC networks. DSC network(s) deployed in FRCAN component 310 and RRDB component 312 improve the network speed, while at the same time reducing the network parameters. The residual learning performed by decoder 201 may generate additional features that have been lost, thereby reducing the code stream after image compression. For example, the channel attention block (CA_Block) 608 of RCAB in FRCAN component 310 may capture informative features by weighting, which may be omitted in the pre-processing network.

At 1408, the apparatus may indicate the set of features to be omitted from the feature maps generated by the pre-processing network. For example, referring to FIG. 3, decoder 201 may indicate which features to omit from the pre-processing to encoder 101. This is because decoder 201, during training, may identify which features its DSC networks can capture that would otherwise be redundant if encoder 101 also captured them in its feature maps.

In various aspects of the present disclosure, the functions described herein may be implemented in hardware, software, firmware, or any combination thereof. If implemented in software, the functions may be stored as instructions on a non-transitory computer-readable medium. Computer-readable media includes computer storage media. Storage media may be any available media that can be accessed by a processor, such as processor 102 in FIGS. 1 and 2. By way of example, and not limitation, such computer-readable media can include RAM, ROM, EEPROM, CD-ROM or other optical disk storage, HDD, such as magnetic disk storage or other magnetic storage devices, Flash drive, SSD, or any other medium that can be used to carry or store desired program code in the form of instructions or data structures and that can be accessed by a processing system, such as a mobile device or a computer. Disk and disc, as used herein, includes CD, laser disc, optical disc, digital video disc (DVD), and floppy disk where disks usually reproduce data magnetically, while discs reproduce data optically with lasers. Combinations of the above should also be included within the scope of computer-readable media.

According to one aspect of the present disclosure, a method of video post-processing is provided. The method may include receiving, by a processor, a plurality of input feature maps associated with an image. The plurality of input feature maps may be generated by a video pre-processing network. The method may include inputting, by the processor, the plurality of input feature maps into a first DSC network of a FRCAN component. The method may include outputting, by the processor, a first set of output feature maps from the first DSC network of the FRCAN component.

In some embodiments, the method may include applying, by the processor, a depth-wise convolution followed by a point-wise convolution to the plurality of input feature maps using the first DSC network. In some embodiments, the method may include generating, by the processor, the first set of output feature maps based on the depth-wise convolution followed by the point-wise convolution.

In some embodiments, the method may include inputting, by the processor, the first set of output feature maps into a residual upsampling component. In some embodiments, the method may include upsampling, by the processor, the first set of output feature maps to generate a set of upsampled feature maps based on a residual upsampling network of the residual upsampling component.

In some embodiments, the method may include inputting, by the processor, the set of upsampled feature maps into a second DSC network of an RRDB component. In some embodiments, the method may include outputting, by the processor, a second set of output feature maps from the second DSC network of the RRDB component.

In some embodiments, the method may include applying, by the processor, a depth-wise convolution followed by a point-wise convolution to the set of upsampled feature maps using the second DSC network. In some embodiments, the method may include generating, by the processor, the second set of output feature maps based on the depth-wise convolution followed by the point-wise convolution.

In some embodiments, the method may include inputting, by the processor, the second set of output feature maps into a WAM component. In some embodiments, the method may include outputting, by the processor, an enhanced set of feature maps from the WAM component.

In some embodiments, the method may include generating, by the processor, a compressed image based on the enhanced set of feature maps.

According to another aspect of the present disclosure, a system for video post-processing is provided. The system may include a memory configured to store instructions. The system may include a processor coupled to the memory and configured to, upon executing the instructions, receive a plurality of input feature maps associated with an image. The plurality of input feature maps may be generated by a video pre-processing network. The system may include a processor coupled to the memory and configured to, upon executing the instructions, input the plurality of input feature maps into a first DSC network of a FRCAN component. The system may include a processor coupled to the memory and configured to, upon executing the instructions, output a first set of output feature maps from the first DSC network of the FRCAN component.

In some embodiments, the processor coupled to the memory may be further configured to, upon executing the instructions, apply a depth-wise convolution followed by a point-wise convolution to the plurality of input feature maps using the first DSC network. In some embodiments, the processor coupled to the memory may be further configured to, upon executing the instructions, generate the first set of output feature maps based on the depth-wise convolution followed by the point-wise convolution.

In some embodiments, the processor coupled to the memory may be further configured to, upon executing the instructions, input the first set of output feature maps into a residual upsampling component. In some embodiments, the processor coupled to the memory may be further configured to, upon executing the instructions, upsample the first set of output feature maps to generate a set of upsampled feature maps based on a residual upsampling network of the residual upsampling component.

In some embodiments, the processor coupled to the memory may be further configured to, upon executing the instructions, input the set of upsampled feature maps into a second DSC network of an RRDB component. In some embodiments, the processor coupled to the memory may be further configured to, upon executing the instructions, output a second set of output feature maps from the second DSC network of the RRDB component.

In some embodiments, the processor coupled to the memory may be further configured to, upon executing the instructions, apply a depth-wise convolution followed by a point-wise convolution to the set of upsampled feature maps using the second DSC network. In some embodiments, the processor coupled to the memory may be further configured to, upon executing the instructions, generate the second set of output feature maps based on the depth-wise convolution followed by the point-wise convolution.

In some embodiments, the processor coupled to the memory may be further configured to, upon executing the instructions, input the second set of output feature maps into a WAM component. In some embodiments, the processor coupled to the memory may be further configured to, upon executing the instructions, output an enhanced set of feature maps from the WAM component.

In some embodiments, the processor coupled to the memory may be further configured to, upon executing the instructions, generate a compressed image based on the enhanced set of feature maps.

According to a further aspect of the present disclosure, a method of video compression is provided. The method may include performing, by a processor, pre-processing of an input image using a pre-processing network to generate an encoded image. The method may include performing, by the processor, post-processing on the encoded image using a post-processing network to generate a decoded compressed image. The pre-processing network and the post-processing network may be asymmetric.

In some embodiments, the method may include identifying, by the processor, a set of features to omit from feature maps generated by the pre-processing network during the pre-processing of the input image. In some embodiments, the set of features to omit from the feature maps may be identified using the post-processing network. In some embodiments, the method may include indicating, by the processor, the set of features to omit from the feature maps generated by the pre-processing network. In some embodiments, the set of features to omit feature maps generated by the pre-processing network may be captured using the post-processing network.

In some embodiments, the performing, by the processor, pre-processing of the input image using the pre-processing network to generate an encoded image may include applying a standard convolution to the input image using a standard convolution component. In some embodiments, the performing, by the processor, pre-processing of the input image using the pre-processing network to generate an encoded image may include applying GDN to the input image using a GDN component after the standard convolution is applied using the standard convolution component. In some embodiments, the performing, by the processor, pre-processing of the input image using the pre-processing network to generate an encoded image may include applying a first WAM to the input image using a first WAM component after the GDN is applied using the GDN component. In some embodiments, the performing, by the processor, post-processing on the encoded image using the post-processing network to generate the decoded compressed image may include applying a second WAM to a set of feature maps generated by the pre-processing network. In some embodiments, the performing, by the processor, post-processing on the encoded image using the post-processing network to generate the decoded compressed image may include applying a first depth-wise separable convolutional (DSC) network of a FRCAN component to the set of feature maps after the second WAM is applied. In some embodiments, the performing, by the processor, post-processing on the encoded image using the post-processing network to generate the decoded compressed image may include applying a second DSC network of an RRDB to the set of feature maps after the first DSC network is applied.

According to yet another aspect of the present disclosure, a system for video compression is provided. The system may include a memory configured to store instructions. The system may include a processor coupled to the memory and configured to, upon executing the instructions, perform pre-processing of an input image using a pre-processing network to generate an encoded image. The system may include a processor coupled to the memory and configured to, upon executing the instructions, perform post-processing on the encoded image using a post-processing network to generate a decoded compressed image. The pre-processing network and the post-processing network may be asymmetric.

In some embodiments, the processor coupled to the memory may be further configured to, upon executing the instructions, identify a set of features to omit from feature maps generated by the pre-processing network during the pre-processing of the input image. In some embodiments, the set of features to omit from the feature maps may be identified using the post-processing network. In some embodiments, the processor coupled to the memory may be further configured to, upon executing the instructions, indicate the set of features to omit from the feature maps generated by the pre-processing network. In some embodiments, the set of features to omit from feature maps generated by the pre-processing network may be captured using the post-processing network.

In some embodiments, the processor coupled to the memory may be configured to perform the pre-processing of the input image using the pre-processing network to generate an encoded image by applying a standard convolution to the input image using a standard convolution component. In some embodiments, the processor coupled to the memory may be configured to perform the pre-processing of the input image using the pre-processing network to generate an encoded image by applying GDN to the input image using a GDN component after the standard convolution is applied using the standard convolution component. In some embodiments, the processor coupled to the memory may be configured to perform the pre-processing of the input image using the pre-processing network to generate an encoded image by applying a first WAM to the input image using a first WAM component after the GDN is applied using the GDN component. In some embodiments, the processor coupled to the memory may be configured to perform the post-processing on the encoded image using the post-processing network to generate the decoded compressed image by applying a second WAM to a set of feature maps generated by the pre-processing network. In some embodiments, the processor coupled to the memory may be configured to perform the post-processing on the encoded image using the post-processing network to generate the decoded compressed image by applying a first DSC network of a FRCAN component to the set of feature maps after the second WAM is applied. In some embodiments, the processor coupled to the memory may be configured to perform the post-processing on the encoded image using the post-processing network to generate the decoded compressed image by applying a second DSC network of an RRDB to the set of feature maps after the first DSC network is applied.

The foregoing description of the embodiments will so reveal the general nature of the present disclosure that others can, by applying knowledge within the skill of the art, readily modify and/or adapt for various applications such embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Summary and Abstract sections may set forth one or more but not all exemplary embodiments of the present disclosure as contemplated by the inventor(s), and thus, are not intended to limit the present disclosure and the appended claims in any way.

Various functional blocks, modules, and steps are disclosed above. The arrangements provided are illustrative and without limitation. Accordingly, the functional blocks, modules, and steps may be reordered or combined in different ways than in the examples provided above. Likewise, some embodiments include only a subset of the functional blocks, modules, and steps, and any such subset is permitted.

The breadth and scope of the present disclosure should not be limited by any of the above-described exemplary embodiments, but should be defined only in accordance with the following claims and their equivalents.

What is claimed is:

1. A method of video post-processing, comprising:
receiving, by a processor, a plurality of input feature maps associated with an image, the plurality of input feature maps being generated by a video pre-processing network;
inputting, by the processor, the plurality of input feature maps into a first depth-wise separable convolutional (DSC) network of a fast residual channel attention network (FRCAN) component; and
outputting, by the processor, a first set of output feature maps from the first DSC network of the FRCAN component.

2. The method of claim 1, further comprising:
applying, by the processor, a depth-wise convolution followed by a point-wise convolution to the plurality of input feature maps using the first DSC network; and
generating, by the processor, the first set of output feature maps based on the depth-wise convolution followed by the point-wise convolution.

3. The method of claim 1, further comprising:
inputting, by the processor, the first set of output feature maps into a residual upsampling component; and
upsampling, by the processor, the first set of output feature maps to generate a set of upsampled feature maps based on a residual upsampling network of the residual upsampling component.

4. The method of claim 3, further comprising:
inputting, by the processor, the set of upsampled feature maps into a second DSC network of a residual-in-residual dense block (RRDB) component; and
outputting, by the processor, a second set of output feature maps from the second DSC network of the RRDB component.

5. The method of claim 4, further comprising:
applying, by the processor, a depth-wise convolution followed by a point-wise convolution to the set of upsampled feature maps using the second DSC network; and
generating, by the processor, the second set of output feature maps based on the depth-wise convolution followed by the point-wise convolution.

6. The method of claim 4, further comprising:
inputting, by the processor, the second set of output feature maps into a window attention mechanism (WAM) component; and
outputting, by the processor, an enhanced set of feature maps from the WAM component.

7. The method of claim 6, further comprising:
generating, by the processor, a compressed image based on the enhanced set of feature maps.

8. The method of claim 1, further comprising:
generating, by the FRCAN component, informative image features to compensate for feature loss during compression.

9. A method of video compression, comprising:
performing, by a processor, pre-processing of an input image using a pre-processing network to generate an encoded image; and
performing, by the processor, post-processing on the encoded image using a post-processing network to generate a decoded compressed image,
wherein the pre-processing network and the post-processing network are asymmetric.

10. The method of claim 9, further comprising:
identifying, by the processor, a set of features to omit from feature maps generated by the pre-processing network during the pre-processing of the input image, the set of features to omit from the feature maps being identified using the post-processing network; and
indicating, by the processor, the set of features to be omitted from the feature maps generated by the pre-processing network,
wherein the set of features to omit from the feature maps generated by the pre-processing network are captured using the post-processing network.

11. The method of claim 9, wherein:
the performing, by the processor, pre-processing of the input image using the pre-processing network to generate the encoded image comprises:
applying a standard convolution to the input image using a standard convolution component;
applying generalized division normalization (GDN) to the input image using a GDN component after the standard convolution is applied using the standard convolution component; and
applying a first window attention module (WAM) to the input image using a first WAM component after the GDN is applied using the GDN component.

12. The method of claim 9, wherein:
the performing, by the processor, post-processing on the encoded image using the post-processing network to generate the decoded compressed image comprises:
applying a second WAM to a set of feature maps generated by the pre-processing network;
applying a first depth-wise separable convolutional (DSC) network of a fast residual channel attention network (FRCAN) component to the set of feature maps after the second WAM is applied; and
applying a second DSC network of a residual-in-residual dense block (RRDB) to the set of feature maps after the first DSC network is applied.

13. A system for video compression, comprising:
a memory configured to store instructions; and
a processor coupled to the memory and configured to, upon executing the instructions:
perform pre-processing of an input image using a pre-processing network to generate an encoded image; and
perform post-processing on the encoded image using a post-processing network to generate a decoded compressed image,
wherein the pre-processing network and the post-processing network are asymmetric.

14. The system of claim 13, wherein the pre-processing network comprises a convolutional downsampling component configured to extract input image features.

15. The system of claim 13, wherein the pre-processing network comprises a generalized divisive normalization (GDN) component configured to normalize intermediate features and increase nonlinearity.

16. The system of claim 13, wherein the pre-processing network comprises a window attention mechanism (WAM) component configured to focus on areas with high contrast and use more bits in these complex areas.

17. The system of claim 13, wherein the post-processing network comprises a WAM component configured to focus on areas with high contrast and use more bits in these complex areas.

18. The system of claim 13, wherein the post-processing network comprises a residual upsampling component configured to perform a mapping from a small rectangle to a large rectangle.

19. The system of claim 13, wherein the post-processing network comprises a fast residual channel attention network (FRCAN) component configured to generate informative image features to compensate for feature loss during compression by using a dense residual structure.

20. The system of claim 13, wherein the post-processing network comprises a residual-in-residual dense block (RRDB) component configured to generate more features to compensate for feature loss during encoding.
